(19) United States
(12) Patent Application Publication
(10) Pub. No.: US 2005/0013261 A1
(43) Pub. Date: Jan. 20, 2005

(54) Reducing address learning in virtual bridged local area networks

(76) Inventor: Michael John Seaman, Belvedere, CA (US)

Correspondence Address: MICHAEL JOHN SEAMAN, 160 BELLA VISTA AVE., BELVEDERE, CA, 94920-2466, US

(21) Appl. No.: 10/888,306

(22) Filed: Jul. 10, 2004

Related U.S. Application Data
(60) Provisional application No. 60/488,277, filed on Jul. 18, 2003.

(51) Int. Cl. H04L 12/28

(52) U.S. Cl. 370/256; 370/395.53

(57) ABSTRACT

An improvement to the learning mechanism used by communication devices in data networks that learn from the source addresses of frames in order to restrict frames transmitted to those sources to the network paths that may lead to those sources reduces the resources required for learning by identifying cases where learning would not affect the network paths used. The improvement is applicable to bridged and virtual Local Area Networks and the devices that support those networks.

### CROSS-REFERENCE TO RELATED APPLICATIONS

The present application claims the benefit under 35 U.S.C. §111(b) and 35 U.S.C. §119(e) of the provisional application No. 60/488,277 filed Jul. 18, 2003, entitled REDUCING ADDRESS LEARNING IN BRIDGED AND VIRTUAL BRIDGED LOCAL AREA NETWORKS, naming inventor Michael John Seaman.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to network protocols and network intermediate devices executing such protocols; and more particularly to the learning of source addresses in bridges.

Local Area Networks (LANs) specified by Institute of Electrical and Electronic Engineers (IEEE) Standards for Metropolitan Area Networks may be connected together with media access control (MAC) bridges. Bridges interconnect LANs so that stations (typically computers) attached to the LANs operate as if they were attached to a single LAN for many purposes. Each bridge has a number of ports that attach, like stations, to the LANs. A bridge selectively forwards data frames received on any one of these ports to the others. An interconnected Bridged Local Area Network provides for an increase in the physical extent, in the number of attached stations, and in the total bandwidth provided by the network. MAC Bridges are specified by IEEE Standard 802.1D (IEEE Standards for Local and Metropolitan Area Networks: Media Access Control (MAC) Bridges) and its amendments and revisions.

When LANs and bridges are physically interconnected, it is possible to create loops in the network by providing more than one path between two LANs. Since the service provided by the Bridged Local Area Network is intended to closely resemble the service provided by a single LAN, and permits the attachment of stations to any LAN, bridges may not add to or otherwise modify the data frames that they forward from one LAN to another to prevent loops. The IEEE 802.1D Standard specifies a distributed protocol that the bridges operate to maintain a fully connected (spanning) and loop-free (tree) active topology for the network.

A bridge learns the source address of each frame and records the port that received the frame together with the address in Filtering Database of the bridge and removes any previous association between that address and another port. The information in the Filtering Database is used to restrict frames destined for individually addressed stations in the network to those LANs that each frame has to traverse to each its destination. On receipt of each frame that is destined for an individual address the bridge consults the Filtering Database. If the address is found the frame is forwarded through the recorded port but not through any other port.

It is possible to use a network of LANs connected by bridges to provide the equivalent of multiple LANs without limiting each of these LANs to a single physical LAN. Such a network is known as a Virtual Bridged Local Area Network and the equivalent LANs provided as Virtual LANs or VLANs. Each VLAN can cover a number of physical LANs interconnected by bridges that is the whole or a connected part of the Virtual Bridged Local Area Network independently of the part covered by any of the other VLANs. VLANs and VLAN-aware Bridges are specified by IEEE Standard 802.1Q (IEEE Standards for Local and Metropolitan Area Networks: Virtual Bridged Local Area Networks) and its amendments and revisions including IEEE Std 802.1s-2002. The IEEE 802.1Q standard specifies a VLAN Identifier (VID) that can be carried in a header added to each frame to identify the unique VLAN for that frame. To allow the same station address to be used to identify different stations on different VLANs a VLAN aware bridge maintains separate Filtering Database entries for separate groups of VLANs. The VIDs of such a group of VLANs identify a single Filtering Identifier or FID.

In a large bridged network it is inconvenient to configure each and every bridge port as to whether a particular VLAN can extend through that port. If the spanning tree active topology changes because of changes in the components of the network then the ports that the VLAN has to extend to reach all the LANs that have attached stations that are to be connected to a VLAN can also change. It is therefore desirable to automatically configure each port using a protocol that transfers information on the spanning tree about the ports that provide connectivity to said attached stations for each VLAN. The IEEE Std 802.1Q specifies the GVRP protocol for this purpose. GVRP updates the Member set of ports for any given VLAN on each bridge in the network if end stations for that VLAN use GVRP to register interest in that VLAN or if bridge ports connected to a LAN where the frames are to be received are appropriately configured. IEEE Std 802.1s specifies the use of multiple spanning trees for the active topology for a network and allows each VLAN to be associated with a specified tree. To support the use of multiple spanning trees GVRP propagates registration information for each VLAN on the appropriate tree for said VLAN.

VLANs are often used to segregate traffic in very large networks including networks such as Metropolitan Area Networks that are designed to serve many independent customers. Between them said customers may have many thousands or even millions of end stations and the addresses of said end stations may be learnt by the bridges in the network. The very large number of address involved are thought by some to impose an undesirably low limit to the scale of the networks that can be constructed with bridges according to the IEEE Std 802.1Q. It is recognized that where such a Metropolitan Area Network is using a VLAN to provide the equivalent of a point to point LAN with customer attachments at only two points it is unnecessary to learn source addresses of frames for said VLAN. Frames transmitted by a customer at one attachment point can only be intended for the other attachment point and vice versa. However the apparent scale limit for VLANs with customer attachments at more than two points has caused some vendors to propose different bridging or bridge related technologies for use in metropolitan area networks that have hiding the addresses from end stations from the bridges within the network as a key feature.

### BRIEF SUMMARY OF THE INVENTION

This invention comprises a method for reducing the number of addresses learnt in MAC Bridges in Virtual Bridged Local Area Networks.

According to the invention, the functionality of a Bridge is extended so that said Bridge only learns a source address of a station from a first frame received on a first Port if learning said address would result in the relay function of the Bridge transmitting a second frame destined to the station with said source address on Ports of the Bridge other than said first Port while learning said address would suppress transmission of said second frame on said other Ports. Specifically said source address is learnt if frames addressed to said station could be transmitted through said first Port and through a second Port and a third Port could receive a frame addressed to said station. Additionally said source address is learnt if a second frame addressed to said station could be transmitted through said first Port and through a second Port and said first Port is attached to a shared medium thus permitting more than one Bridge to transmit directly on said shared medium. In a VLAN-aware Bridge said second frame is any frame that is assigned to a VLAN that shares the same FID as the VLAN associated with said first frame.

Further, according to the invention, automatic configuration protocols such as GVRP can be used to determine the Ports that any frame assigned to a first VLAN can be transmitted through so that a sufficient but minimal number of source addresses are learnt by a VLAN-aware Bridge using the previously describe extended functionality of the invention even after the network has reconfigured due to failure or removal or addition of a network component.

Further, according to the invention, if it is known that the information learnt from the source addresses of frames received on a first VLAN is only used to determine filtering of frames transmitted on a second VLAN by a bridge then a source address is only learnt on said first VLAN by the Filtering Database of said bridge if the frame carrying said source address is received on a port that can be used to transmit a frame on said second VLAN and that there exists a first port on said bridge that can receive frames from said second VLAN and there also exists two or more ports on said bridge distinct from said first port that can transmit frames on said second VLAN.

Further, according to the invention, if it is known that the information learnt from the source addresses of frames received on a first VLAN is used to determine filtering of frames transmitted on one or more of a plurality of VLANs by a bridge and not used to determine the filtering of frames on any other VLAN not of said plurality then a source address is only learnt on said first VLAN by the Filtering Database of said bridge if the frame carrying said source address is received on a port that can be used to transmit a frame on a second VLAN of said plurality of VLANs and that there exists a first port on said bridge that can receive frames from said second VLAN and there also exists two or more ports on said bridge distinct from said first port that can transmit frames on said second VLAN.

In a Virtual Bridged Local Area Network located within a single premises or campus and operated for the use of a single enterprise, each VLAN is typically principally confined to a part of the overall network topology and most of the Bridges that forward frames assigned to that VLAN forward said frames on more than two Ports. In such a Virtual Bridged Local Area Network the present invention may have little effect on the number of addresses learnt by each Bridge. However in a public service network such as a Metropolitan Area Network (MAN) using MAC Bridge technology the items of equipment controlled by each customer are typically attached to the public service network in fewer places than there are bridges in the network. The maximum number of bridges that will learn a given address for a given customer will be two less than the number of customer attachment points. Typically customer attachments points are clustered together or the design of the network can increase the chance that the active topology used by a given customer has several branches at particular bridges thus minimizing the number of other bridges that need to learn addresses for that customer.

### BRIEF DESCRIPTION OF THE SEVERAL VIEWS OF THE DRAWING

FIG. 1 illustrates an example network configuration of bridges and LANs with customer equipment attached and shows the active topology calculated by a spanning tree protocol.

FIG. 2 clarifies the active topology of the network configuration of FIG. 1 by omitting LANs and ports that are not used to forward frames between bridges or to the attached customer equipment. The advantages of the present invention are illustrated by identifying a bridge that do not learn the source addresses of the attached customer equipment according to the present invention but would learn said source addresses according to IEEE Std 802.1D.

FIG. 3 illustrates the active topology of a network of the same configuration as FIG. 2 but with the use of VLAN-aware bridges according to IEEE Std 802.1Q rather than bridges according to IEEE Std 802.1D. FIG. 3 further illustrates the use of the GVRP protocol to identify the VLAN member set for each bridge.

FIG. 4 illustrates the change in the active topology of the network of FIG. 3 after a LAN has been removed. FIG. 4 shows how the change in active topology results in changes in the selection of the bridges that need to learn the source address of the customer equipment attached to the network.

FIG. 5 illustrates a network of VLAN-aware bridges and LANs connected in a ring with customer equipment also attached to some of the bridges and shows an active topology calculated for some of the VLANs by a spanning tree protocol.

FIG. 6 clarifies the active topology of the network of FIG. 5 by omitting LANs and ports not selected by GVRP to forward frames between the attached customer equipment. FIG. 6 shows how the present invention further reduces the number of bridges that have to learn source addresses from the attached customer equipment as compared to bridges according to IEEE Std 802.1Q.

### DETAILED DESCRIPTION OF THE INVENTION

A detailed description of the present invention is provided with reference to the figures.

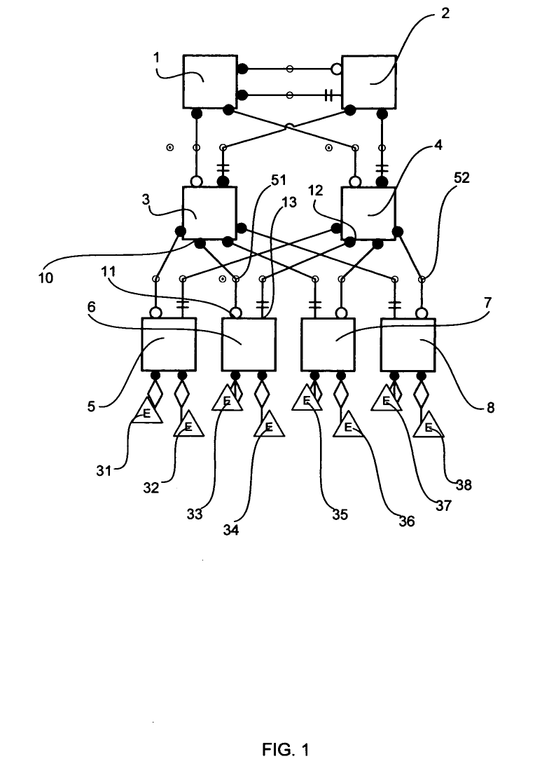

FIG. 1 shows an example network using the diagrammatic conventions specified in IEEE Standard 802.1s-2002 FIG. 13-1 known to those skilled in the art. Bridges 1 thru 8 are connected by their Ports to point to point LANs. Ports 10 thru 14 and LANs 51 and 52 are identified by way of example. Customer equipment or customer networks 31 thru 38 are attached to bridges 5 thru 8.

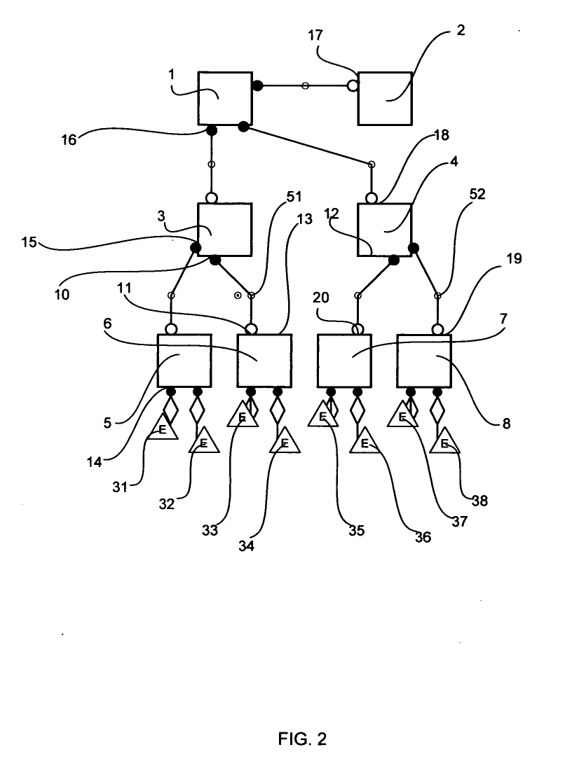

FIG. 2 clarifies the active topology of the network configuration of FIG. 1 by omitting LANs and ports that are not used to forward frames between bridges or to the attached customer equipment. According to IEEE Std 802.1D the source address of multicast frame transmitted by customer equipment 31 is learnt by all the bridges. Said source address is learnt by bridge 5 on port 14 by bridge 3 on port 15 by bridge 1 on port 16 by bridge 2 on port 17 by bridge 4 on port 18 by bridge 7 on port 20 and by bridge 8 on port 19. According to the improvement of the present invention said source address is not learnt by bridge 2.

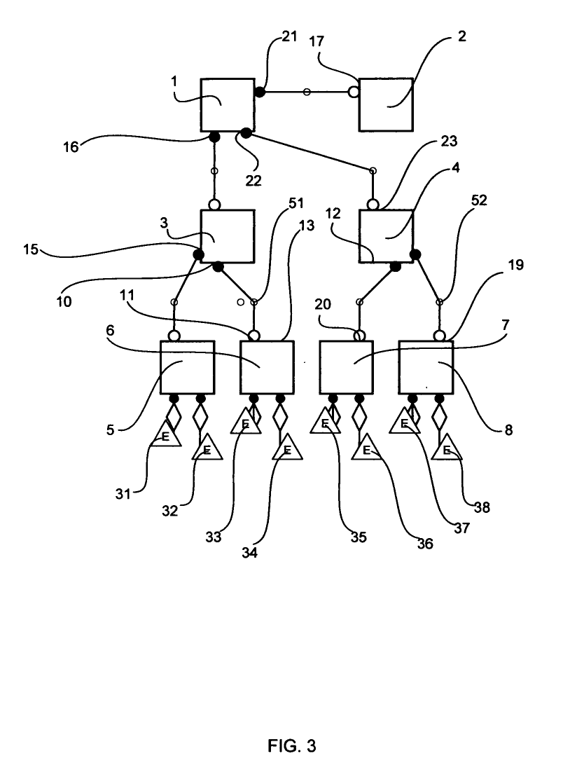

FIG. 3 illustrates the active topology of a network of the same configuration as FIG. 2 but with the use of VLAN-aware bridges according to IEEE Std 802.1Q rather than bridges according to IEEE Std 802.1D. All the customer equipment and customer networks shown 31 thru 38 use the same VLAN and GVRP is used according to IEEE Std 802.1Q to register and add ports to the member set for said VLAN. All ports shown as attached to LANs with the exception of port 21 on bridge 1 will be added to the member set for said VLAN. According to IEEE Std 802.1Q source addresses of frames transmitted on said VLAN will be learnt in all bridges as received on all said ports with the exception of port 21. According to the improvement of the present invention said source addresses are not learnt on ports 16 and 21 and 22 of bridge 1.

If in FIG. 3 a first group of customer equipment 31 thru 34 communicates with a second group of customer equipment 35 thru 38 by said first group transmitting on a first VLAN and receiving on a second VLAN and registering for receipt on said second VLAN using GVRP while said second group transmits on said second VLAN and receives on said first VLAN and registers for receipt on said first VLAN using GVRP and use of information learnt from said first VLAN to filter frames on said second VLAN is enabled by said first VLAN and said second VLAN sharing the same FID in all bridges shown then said second VLAN will be registered for receipt on the ports shown as attached to 31 thru 34 on bridges 5 and 6 and on ports 15 and 10 and 16 and 17 and 23 and 19 and 20 then, according to the invention, source addresses from frames transmitted on said second VLAN will be learned on ports on bridges 7 and 8 and 4 and not on bridges 1 and 3 and 5 and 6 and 2 as would also be required according to IEEE Std 802.1Q.

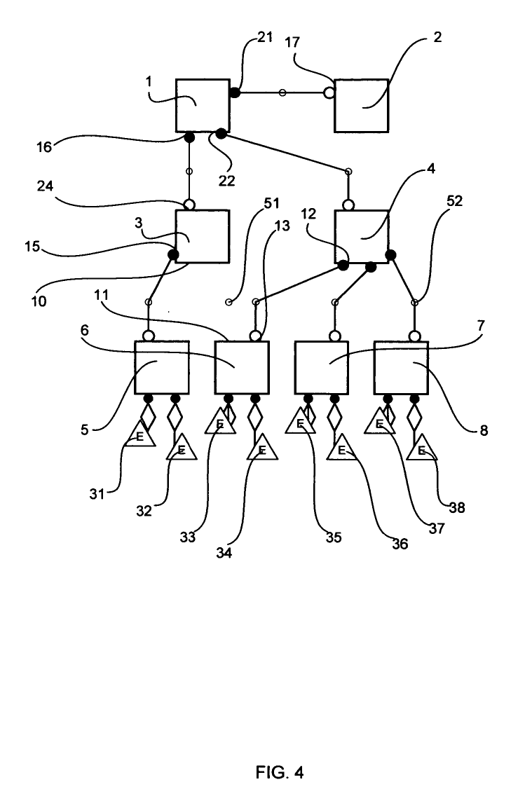

FIG. 4 illustrates the change in the active topology of the network of FIG. 3 after a LAN has been removed. All the customer equipment and customer networks shown 31 thru 38 use the same VLAN and GVRP is used according to IEEE Std 802.1Q to register and add ports to the member set for said VLAN. All ports shown as attached to LANs with the exception of port 21 on bridge 1 will be added to the member set for said VLAN. According to IEEE Std 802.1Q source addresses of frames transmitted on said VLAN will be learnt in all bridges as received on all said ports with the exception of port 21. According to the improvement of the present invention said source addresses are not learnt on ports 16 and 21 and 22 of bridge 1 and ports 24 and 15 of bridge 3.

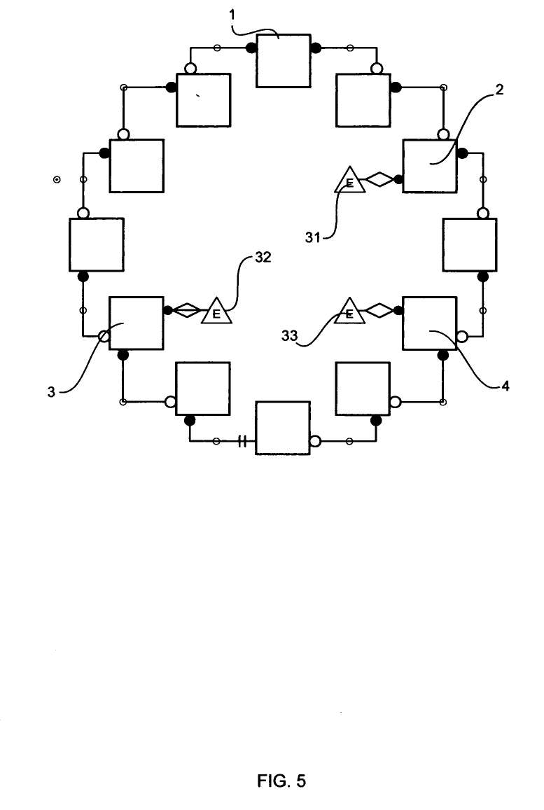

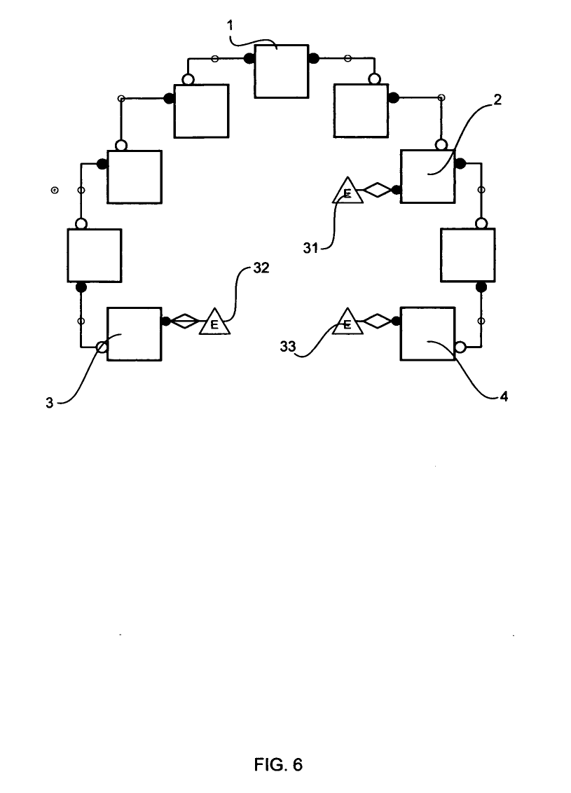

FIG. 5 shows an example network of VLAN-aware bridges and an active topology calculated for some of the VLANs by a spanning tree protocol using the diagrammatic conventions specified in IEEE Std 802.1w-2001 FIG. 17-1 and IEEE Standard 802.1s-2002 FIG. 13-1 known to those skilled in the art. Customer equipment or customer networks 31 thru 33 are attached to bridges 2 thru 4 respectively and use a VLAN provided by the network to communicate. FIG. 6 clarifies the active topology of said VLAN by omitting LANs and ports not selected by GVRP to forward frames using said VLAN. According to IEEE Std 802.1Q source address of frames transmitted on the VLAN used by 31 thru 33 will be learned by all bridges shown including for example by bridge 1. According to the present invention said source addresses will only be learnt on bridge 2 as that is the only bridge that can receive a frame on a first port and then have a choice amongst second ports to forward the frame.

The present invention is not limited to the field of Bridged Local Area Networks and may be applied whenever learning of source addresses is desired, so as to reduce the number of addresses learnt.

The foregoing description of preferred embodiments of the invention has been presented for the purposes of illustration and description. The description is not intended to be exhaustive or to limit the invention to the precise forms disclosed. Many modifications and variations will be apparent to practitioners skilled in this art.

1. For a network comprising a plurality of communication links connected by a plurality of network devices said network being capable of transmitting frames of data, a network device comprising:
a plurality of ports coupled to communication links in the network;
resources that associate each of a plurality of addresses each of a station attached to or reached through the network with the port on the device receiving a frame with said address;
additional logic that reduces the requirement for or use of said resources by omitting to record or removing the recorded association between an address and a port on the device by identifying when the recorded association would not affect the transmission of frames to that address by the device.

2. The network device of claim 1, wherein the additional logic is used to identify for a first frame transmitted by a station and received on a first port if a second frame received on a second port and addressed to said station could be transmitted on both said first port and on a third port if the address of the station transmitting said first frame is not associated with said first port.

3. The network device of claim 1, wherein the ports that a frame may be transmitted on and or received from are constrained by associating said frame with a virtual network comprising a subset of a plurality of interconnected network devices and communications links.

4. The network device of claim 2, wherein the ports that a frame may be transmitted on and or received from are constrained by associating said frame with a virtual network comprising a subset of a plurality of interconnected network devices and communications links.

5. The network device of claim 1, wherein the ports that a frame may be transmitted on and or received from are determined by the operation of a protocol and may change from time to time.

6. The network device of claim 2, wherein the ports that a frame may be transmitted on and or received from are determined by the operation of a protocol and may change from time to time.

7. The network device of claim 1, wherein the device is designed to interoperate with a network device according to revision or version of IEEE Std 802.1D or IEEE Std 802.1Q or a specification derived from or fully or partially compatible with or fully or partially interoperable with one or more of those standards.

8. The network device of claim 2, wherein the device is designed to interoperate with a network device according to revision or version of IEEE Std 802.1D or IEEE Std 802.1Q or a specification derived from or fully or partially compatible with or fully or partially interoperable with one or more of those standards.

9. The network device of claim 5, wherein the device is designed to interoperate with a network device according to revision or version of IEEE Std 802.1D or IEEE Std 802.1Q or a specification derived from or fully or partially compatible with or fully or partially interoperable with one or more of those standards.

10. The network device of claim 6, wherein the device is designed to interoperate with a network device according to revision or version of IEEE Std 802.1D or IEEE Std 802.1Q or a specification derived from or fully or partially compatible with or fully or partially interoperable with one or more of those standards.
